(19) United States
(12) Patent Application Publication
(10) Pub. No.: US 2004/0120672 A1
(43) Pub. Date: Jun. 24, 2004

(54) Waveguides with integrated lenses and reflective surfaces

(76) Inventors: Gabel Chong, Mountain View, CA (US); Hiroaki Fukuto, Los Altos Hills, CA (US); Xuejun Ying, San Jose, CA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/323,207

(22) Filed: Dec. 18, 2002

(51) Int. Cl. G02B 6/10

(52) U.S. Cl. 385/129

(57) ABSTRACT

Optical waveguides with integrated collimating lenses and/or reflectors or mirrors are disclosed. The waveguides can include a convex collimating lens disposed at an end of the core. An integrated reflecting device may be inserted into the core so that at least a portion of the signal is directed upward through a convex collimating lens disposed above the upper cladding and core for power monitoring. An additional integrated reflecting device may be incorporated beyond a distal end of the core of the waveguide for power monitoring. The lenses and reflective devices or mirrors are made using reflow techniques and therefore do not require the use of separate, prefabricated components.

### TECHNICAL FIELD

Waveguides with integrated lenses, mirrors and optical detectors are disclosed. Further, methods of manufacturing waveguides with integrated lenses and/or mirrors are also disclosed. The waveguides with integrated lenses and/or mirrors may be used in variable optical attenuators, arrayed waveguide gratings, evanescent couplers and other photonic architectures that require focusing and/or optical detection or power monitoring.

### DESCRIPTION OF THE RELATED ART

There is a wide-ranging demand for increased communications capabilities, including more channels and greater bandwidth per channel. The needs range from long distance applications such as telecommunications between two cities to extremely short range applications such as the data-communications between two functional blocks (fubs) in a semiconductor circuit with spacing of a hundred microns.

Optical media, such as optical fibers or waveguides, provide an economical and higher bandwidth alternative to electrical conductors for communications. A typical optical fiber includes a silica core, a silica cladding, and a protective coating. The index of refraction of the core is higher than the index of refraction of the cladding to promote internal reflection of light propagating down the silica core.

Optical fibers can carry information encoded as optical pulses over long distances. The advantages of optical media include vastly increased data rates, lower transmission losses, lower basic cost of materials, smaller cable sizes, and almost complete immunity from stray electrical fields. Other applications for optical fibers include guiding light to awkward places (e.g., surgical applications), image guiding for remote viewing, and various sensing applications.

The use of optical waveguides in circuitry to replace conductors isolates path length affects (e.g., delays) from electrical issues such as mutual impedance. As a result, optical interconnects and optical clocks are two applications for waveguide technology. Like optical fibers, waveguides include a higher index of refraction core embedded in a lower index of refraction cladding.

Wavelength Division Multiplexing (WDM) represents an efficient way to increase the capacity of an optical fiber. In WDM, a number of independent transmitter-receiver pairs use the same fiber.

An arrayed waveguide grating (AWG) is a component used in fiber optics systems employing WDM. The various elements of an AWG are normally integrated onto a single substrate. An AWG comprises a plurality of optical input/output waveguides on both sides of the substrate, two slab waveguides, and a grating that consists of channel waveguides that connect the slab waveguides together, which in turn, connect the input/output guides to the separate channel waveguides.

In an optical communications system, it is often required to adjust the intensity or optical power of the light signals being transmitted. Variable optical attenuators (VOA) are typically used to control the intensity of each light signal, and thereby maintain each light signal at the same intensity. Generally, a VOA attenuates, or reduces, the intensity of some of the light signals so that all of the light signals are maintained at the same intensity.

An evanescent coupler is formed with two waveguides disposed together in a substrate and that extend for a coupling distance close to each other, such that the light wave modes passing along each waveguide overlap. The overlap causes some light from one waveguide to pass to the other, and vice versa. The two waveguides in the evanescent coupler separate away from each other outside of the coupling distance.

In the architectures of many photonics devices, such as AWGs, VOAs, optical power monitors, and evanescent couplers, it is desirable to perform optical detection or power monitoring at an upper surface of the planar lightwave circuit (PLC). Consequently, planar lightwave circuits have been developed with mirrors positioned beneath a mounted detection device which enable exchange of optical signals between the waveguide and the detection device.

Typically, such mirrors have reflective surfaces positioned opposite a terminal end of the waveguide core and at an approximately 45° angle relative to the longitudinal axis of the core which results in the signal being reflected at an angle perpendicular to the core.

However, the mirrors or reflective surfaces, along with the waveguides, must be prefabricated and subsequently assembled or secured to the substrate. Such prefabrication is expensive and undesirable when mass producing components. Other processes that do not require prefabrication have been developed but these processes typically require multiple etching steps and often require the mirror to be made from a different material than the core or cladding of the waveguide. Accordingly, a more economic means is needed for fabricating mirrors or reflective surfaces in planar lightwave circuits.

Further, waveguide lenses are indispensable elements in numerous photonics devices, such as those described above. Specifically, waveguide lenses are often needed when it is necessary to provide efficient optical coupling between components or devices of a circuit or system. The coupling or inner connection between various devices or components can be complicated if there is any mismatch between an output or aperture of one device and an input or aperture of another device. The coupling or inner connection problem is exacerbated by the use of small diameter optical fibers which typically have a diameter on the order of 125 μm as an outer diameter and a core diameter as small as 8 μm. Thus, the mechanical alignment of a fiber with another optical component can be extremely difficult and mismatches often result.

Some lenses incorporated into the photonics devices include tapered hemispherical fiber lenses which must be made on an individual basis and therefore encounter quality control problems. Laser machine lenses are another alternative but must also be made individually and therefore are costly and time consuming. Finally, lenses have also been etched on tips of glass fibers. Although these etched lenses are relatively inexpensive because they are subject to batch processing, quality control problems arise from the fact that the etched lenses are subject to etching related defects and are subject to damage during handling.

Thus, there is a need for improved methods of incorporating mirrors or reflective surfaces and lenses into various photonics devices.

### BRIEF DESCRIPTION OF THE DRAWINGS

The disclosed devices and methods of fabrication thereof are illustrated more or less diagrammatically in the accompanying drawings, wherein:

FIG. 1A is a sectional view illustrating a substrate, lower cladding layer and core layer with the lower cladding and core etched prior to deposition of the upper cladding layer;

FIG. 1B is a sectional view of the substrate, lower cladding layers of FIG. 1A with an upper cladding layer deposited thereon;

FIG. 1C is a sectional view of the substrate, lower and upper cladding layers and core layer of FIG. 1B after the upper cladding layer has been etched;

FIG. 1D is a sectional view of the substrate, lower and upper cladding layers and core layer of FIG. 1C after the upper cladding layer has been reflowed to form a convex lens;

FIG. 2A is a sectional view of a substrate and cladding layer wherein the cladding layer has been etched to form a distal wall;

FIG. 2B is a sectional view of the substrate and cladding of FIG. 2A after the cladding material has been reflowed to convert the distal wall shown in FIG. 2A to a sloped or otherwise curved surface;

FIG. 2C is a sectional view of the substrate and reflowed cladding shown in FIG. 2B after the deposition of a reflective surface on the curved or sloped surface of the cladding and further illustrating the placement of a detector or monitor disposed above the reflective surface.

FIG. 3A is a sectional view of a substrate and etched cladding layer;

FIG. 3B is a sectional view of the substrate and cladding of FIG. 3A after the cladding has been reflowed to form a meniscus or convex lens; and

FIG. 3C is a sectional view of a substrate, waveguide which includes a lower cladding, core and upper cladding, a reflector disposed in the core of the waveguide, a top or cap layer and a convex lens formed from reflowed cladding material as illustrated in FIGS. 3A and 3B.

It should be understood that the drawings are not necessarily to scale and that the embodiments are illustrated by diagrammatic representations, fragmentary views and graphical representations. In certain instances, details which are not necessary for an understanding of the disclosed devices and methods or which render other details difficult to perceive may have be omitted. It should be understood, of course, that this disclosure is not necessarily limited to the particular embodiments illustrated herein.

### DETAILED DESCRIPTION OF THE PRESENTLY PREFERRED EMBODIMENTS

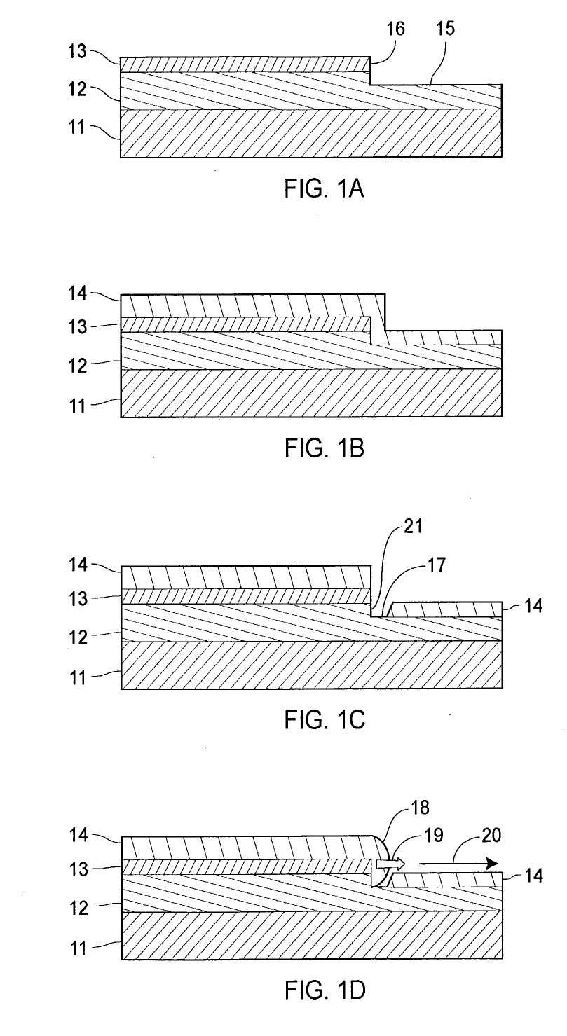

FIG. 1A illustrates a substrate 11, a lower cladding 12 and a core 13 that has been etched to form a trench 15 in the lower cladding 12 defined by a distal end 16 of the core 12. In FIG. 1B, an upper cladding 14 has been deposited on the entire structure in a manner such that it extends beyond a distal end 16 of the core 13. To form a convex lens at the distal end 16 of the core 13, the upper cladding 14 is etched at the distal end of the core as shown in FIG. 1C to expose a portion 17 of the lower cladding 12 as shown in FIG. 1C. Then, the upper cladding 14 is heated to a reflow condition resulting in a convex lens 18 as shown in FIG. 1D. The convex lens 18 is formed as a result of surface diffusion effects generated by the reflow process. The convex lens 18 can be used to collimate or focus a light signal propagating through the core 13. The collimating effect of the convex lens 17 is illustrated by the arrows 19 and 20 which illustrate a focusing of a light signal exiting the core 13. As a result, the waveguide 10a illustrated in FIG. 1D has improved coupling characteristics as opposed to conventional waveguides.

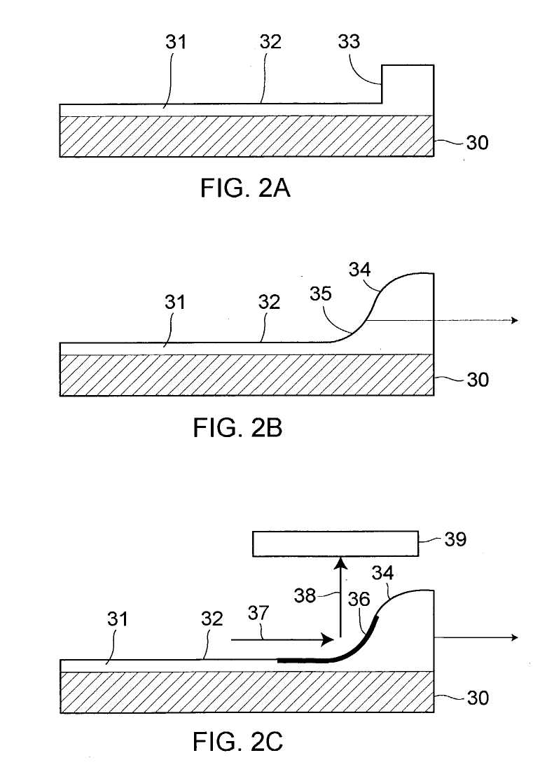

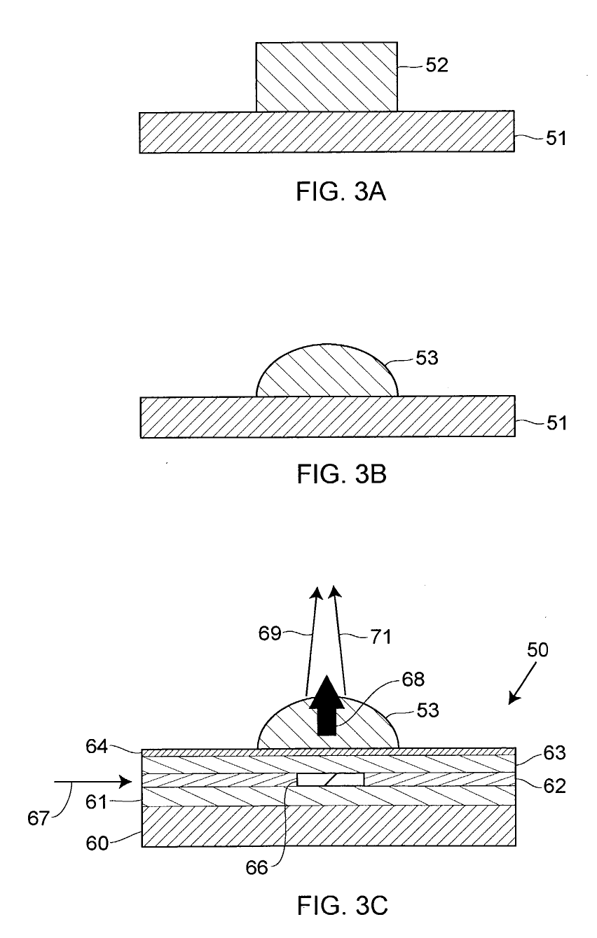

Turning to FIGS. 2A-2C, a reflection or deflecting device is illustrated which can be incorporated into a waveguide structure such as that illustrated in FIG. 3C. Specifically, a substrate 30 is coated with a layer of cladding material 31 which is subsequently etched to form a bottom surface 32 and an upwardly extending distal wall 33. Similar to the embodiment illustrated in FIGS. 1A-1D, the cladding material is then reflowed to form the sloped structure illustrated in FIG. 2B. Specifically, the bottom surface of the cladding is joined to the sloped wall 34 by a concave surface 35. The concave surface 35 is essentially a concave meniscus which then can be utilized to provide a reflective surface as illustrated in FIG. 2C. Specifically, the surface 35 is coated with a reflective material 26 which can then be used to reflect light propagating in the direction of the arrow 37 upwardly in the direction of the arrow 38 to a detector or monitor shown at 39. The structure of FIG. 3C can be fabricated at a distal end of a waveguide such as that shown at 10b in FIG. 1B or, may be incorporated into a waveguide 50 as shown in FIG. 3C.

Turning to FIGS. 3A-3C, an additional embodiment of a concave focusing or collimating lens is illustrated. In FIG. 3A, substrate 51 is provided with an etched cladding deposit 52. The cladding material is then reflowed to form a convex lens 53 as shown in FIG. 3B. Such a structure may be disposed on top of a waveguide 50 as shown in FIG. 3C. Specifically, a substrate 60 is coated with a lower cladding 61, a core 62, an upper cladding 63 and a top or cap layer 64. The top or cap layer 64 may be an oxide layer. Then, cladding material is deposited and etched to form a cladding structure 52 as illustrated in FIG. 3A. Again, taking advantage of surface diffusion effects generated by the reflow process, the cladding is then reflowed as illustrated in FIG. 3B to form the convex focusing lens 53 as shown. A reflecting device 66 is incorporated into the core 62. The reflecting device 66 may be a conventional prefabricated mirror device or may comprise etched and reflowed core material similar to the process illustrated in FIGS. 2A-2C. Light transmitted in the direction of the arrow 67 propagates down the core 62 to the reflecting device 66 where it is reflected upward in the direction of the arrow 68 and the collimated by the lens 53 as indicated by the arrows 69, 71.

Thus, a plurality of waveguides or planar lightwave circuits are disclosed with integrated reflecting surfaces for use with optical power monitoring or optical detectors and with collimating lenses for enhanced coupling to other devices such as other circuit components or detectors. Further, the integrated convex collimating lenses can be used with evanescent couplers with or without power monitoring or optical detection capabilities. The power monitoring or optical detection capabilities provided by the integrated reflectors and lenses of the disclosed devices are applicable to variable optical attenuators, arrayed waveguide gratings and other optical devices. Further, numerous manufacturing techniques for producing the disclosed devices are also shown and described. These techniques take advantage of surface diffusion effects cause when cladding material is reflowed.

In the foregoing detailed description, the disclosed structures and manufacturing methods have been described with reference exemplary embodiments. It will, however, be evident that various modifications and changes may be made thereto without departing from the broader spirit and scope of this disclosure. The above specification and figures accordingly are to be regarded as illustrated rather than restrictive. Particular materials selected herein can be easily substituted for other materials that will be apparent to those skilled in the art and would nevertheless remain equivalent embodiments of the disclosed devices and manufacturing methods.

What is claimed is:

1. A waveguide comprising:
a lower cladding,
a core disposed on the lower cladding, the core having a distal end and a distal portion of the lower cladding extending beyond the distal end of the core,
an upper cladding disposed on the core and having a distal portion extending around the distal end of the core,
the distal portion of the lower cladding forming a convex lens.

2. The waveguide of claim 1 wherein the convex lens comprises reflowed material from the upper cladding.

3. The waveguide of claim 1 wherein the distal portion of the lower cladding that extends beyond the distal end of the core comprises a trench in the lower cladding extending from the distal end of the core and away from the core, the lower cladding comprising a vertical wall disposed beneath the distal end of the core.

4. The waveguide of claim 3 wherein the convex lens covers the distal end of the core and at least a portion of the vertical wall of the lower cladding.

5. The waveguide of claim 1 wherein the distal portion of the lower cladding that extends beyond the distal end of the core is partially covered with upper cladding material.

6. A method of fabricating a waveguide with a convex optical lens, the method comprising:
coating a substrate with a lower cladding,
coating the lower cladding with a core,
etching the core to form a distal end thereof and exposing a portion of the lower cladding extending beyond the distal end of the core,
coating the core and the distal portion of the lower cladding with an upper cladding,
etching the upper cladding to expose the distal end of the core,
heating the upper cladding to reflow the upper cladding to form a convex lens covering the distal end of the core.

7. The method of claim 6 wherein the etching of the core also results in an etching of the distal portion of the lower cladding to form a trench in the distal portion of the cladding and a vertical wall in the cladding disposed below the distal end of the core.

8. The method of claim 7 wherein the convex lens covers at least a portion of the vertical wall of the lower cladding.

9. A waveguide circuit with a waveguide and reflector directing light perpendicular to the waveguide, the circuit comprising:
a waveguide terminating at a trench disposed in a cladding, the trench further comprising a distal wall comprising a reflective surface disposed at an angle relative to the waveguide of greater than 90°.

10. The circuit of claim 9 further comprising a detector disposed above of the cladding and the trench.

11. The circuit of claim 9 wherein the detector is an InGaAs photodetector.

12. The circuit of claim 9 wherein the detector is an array of InGaAs photodetectors.

13. The circuit of claim 9 wherein the trench further comprises a bottom surface, and the reflective surface and at least part of the bottom surface form a concave meniscus that is coated with a reflective coating.

14. The circuit of claim 13 wherein the reflective coating is selected from the group consisting of epoxy, solder, eutectic, metal and combinations thereof.

15. The circuit of claim 9 wherein the trench and distal wall comprise cladding material.

16. The circuit of claim 9 wherein the trench and distal wall comprise core material.

17. A method of fabricating a planar waveguide with an optical detector, the method comprising:
forming a planar waveguide on a substrate, the substrate extending beyond a distal end of the waveguide,
coating the substrate disposed beyond the distal end of the waveguide with cladding material or core material,
etching a trench in the cladding or core material that extends longitudinally from the waveguide and which terminates at a distal wall opposite the trench from the waveguide,
heating the cladding or core material and reflowing the cladding or core material to form a concave meniscus at a junction of the distal wall and a bottom of the trench,
coating the concave meniscus with a reflective coating,
mounting a detector above the reflective coating.

18. The method of claim 17 wherein the reflective coating is selected from the group consisting of epoxy, solder, eutectic alloy, metal and combinations thereof.

19. The method of claim 17 wherein the meniscus provides an angle of reflection with respect to the waveguide of greater than 90°.

20. A waveguide comprising:
a lower cladding disposed on a substrate,
a core disposed on the lower cladding, the core comprising a reflective surface for reflecting light extending through the core in a generally upward direction,
an upper cladding disposed on the core and over the reflective surface,
a convex lens above the upper cladding and above the reflective surface.

21. The waveguide of claim 20 further comprising a detector disposed above the convex lens.

22. The waveguide of claim 20 wherein the convex lens comprises reflowed cladding material.

23. The waveguide of claim 20 wherein the core comprises a trench disposed therein that terminates at a distal wall, the distal wall comprising a reflective surface disposed at an angle greater than 90° with respect to the core.

24. The waveguide of claim 23 wherein the trench further comprises a bottom surface, and the reflective surface and at least part of the bottom surface form a concave meniscus that is coated with a reflective coating.

25. The waveguide of claim 24 wherein the reflective coating is selected from the group consisting of epoxy, solder, eutectic, metal and combinations thereof.

26. A method of fabricating a waveguide with a convex lens, the method comprising:
coating a substrate with a lower cladding,
coating the lower cladding with a core,
etching a trench longitudinally through a distal portion of the core to provide a distal wall of the trench opposite the trench from a proximal portion of the core,
forming a reflective surface at a junction of the distal wall and a bottom surface of the trench,
coating the core, trench and reflective surface with a first upper cladding,
coating the first upper cladding with a cap layer,
coating a portion of the cap layer aligned with the reflective coating with a second upper cladding,
heating and reflowing the second upper cladding to form a convex lens disposed above the reflective surface.

27. The method of claim 26 further comprising mounting a detector above the convex lens.

28. The method of claim 26 wherein the reflective coating is selected from the group consisting of epoxy, solder, eutectic alloy, metal and combinations thereof.

29. The method of claim 26 wherein reflective surface is formed by reflowing the core at a junction of the bottom surface of the trench and the distal wall to form a concave meniscus which provides an angle of reflection with respect to the core of greater than 90°.

30. The method of claim 26 wherein the coating a portion of the cap layer with a second upper cladding comprises coating the cap layer with the second upper cladding and etching the second upper cladding leaving a discreet layer of second upper cladding aligned with the reflective coating.
